(19) United States
(12) Patent Application Publication
(10) Pub. No.: US 2015/0210034 A1
(43) Pub. Date: Jul. 30, 2015

(54) MULTILAYERED TEXTILE MATERIAL FOR FORMING THREE DIMENSIONAL OBJECTS

(71) Applicant: adidas AG, Herzogenaurach (DE)

(72) Inventors: James Tarrier, Nurnberg (DE); Robert Leimer, Portland, OR (US); Chris Holmes, Veitsbronn (DE); Mark Henderson, Portland, OR (US)

(73) Assignee: adidas AG, Herzogenaurach (DE)

(21) Appl. No.: 14/165,468

(22) Filed: Jan. 27, 2014

(51) Int. Cl. B32B 5/12; B32B 5/02; B32B 27/12; B32B 27/40; B32B 5/26

(52) U.S. Cl. CPC B32B 5/12; B32B 27/40; B32B 5/26; B32B 27/12; B32B 5/024; B32B 2307/51; B32B 2307/724; B32B 2262/0253; B32B 2307/402; B32B 2307/516; B32B 2437/02

(57) ABSTRACT

Described are multilayered materials for forming three dimensional objects. The multilayered materials include at least three nonwoven fiber layers with unidirectionally oriented fibers and a matrix material. The multilayered materials have elastic properties that allow the multilayered material to deform by stretching the multilayered material over a three dimensional mold to form a three dimensional object.

### FIELD OF THE INVENTION

The present invention relates to a material for three dimensional products with a very low weight and improved tensile strength.

### BACKGROUND

For many years, there has been a need to develop lighter and stronger materials to improve quality, safety, and efficiency in a vast array of industries, including but not limited to aerospace, automotive, marine, apparel, sporting goods, fiber optics, industrial safety, military and law enforcement, and electronics.

Since the 1950's, there have been numerous breakthroughs in the development of high performance fibers having many times the strength of steel at a fraction of the weight. Examples of such high performance fibers include but are not limited to polyester fibers (such as the products sold under the trade name Dacron®), nylon fibers, aramid fibers (such as the products sold under the trade names Kevlar®, Techora®, and Twaron®), carbon fibers, ultra high molecular weight polyethylene (“UHMWPE”) (such as products sold under the trade names Ceran®, Dyneema®, and Spectra®), liquid crystal polymers (“LCP”) (such as products sold under the trade name Vectran®) and (poly (p-phenylene-2,6-benzobisoxazole)) (“PBO”) (such as products sold under the trade name Zylon®), and polyethylene naphthalate PEN fibers (such as products sold under the trade name Pentex®). For many years, these high performance fibers have been used in woven and non-woven arrangements to form multilayered composites and laminated structures.

For example, WO 2012/018959 describes the problems with using the high performance fibers in a woven configuration. Specifically, the weaving processes induce crimp in the fibers, which cause stress concentrations and wear points that significantly reduce the strength and long term performance of the fabric.

U.S. Pat. No. 5,333,568 also describes the crimping problem with woven configurations, while describing a reinforced nonwoven laminate that utilizes a reinforcing sheet of unidirectional extruded fibers in which the reinforcing sheet or sheets form one or more uni-tapes laminated to outer layers of polyester film. The fibers are uniformly embedded in the uni-tape via an elastomeric polymer matrix. The low elasticity of the high performance fibers ensures that the laminate does not stretch under a load applied in the direction of the fiber orientation. While stretch resistance is a key parameter for applications such as sails, where the laminate must be flexible without deforming under a load, such stretch resistance is problematic when the laminate is used in a process that requires some material deformation to form three dimensional objects.

In many cases, the materials described in U.S. Pat. No. 5,333,568 are manufactured with two or four layers of UHMWPE fibers sandwiched between two outer layers of polyester, wherein the fibers are superimposed in non-bias (0°/90°) and bias (0°/90°/+45°/−45°) configurations in a variety of weights. Other outer layer materials that have been used with the UHMWPE fiber layers include elastomeric thermoset polymers (such as urethanes and silicones), thermoplastics (such as nylon), low density polyethylene, polypropylene, thermoplastic polyurethanes, and hot melt adhesives (such as polyolefins and polyamides).

While having a very low weight and high tensile strength, these materials have issues with crinkling, noise, unpleasant textures, and a lack of elasticity and softness. In short, the material has the look and feel of a crinkly plastic bag. Furthermore, in use, the materials often lack seam strength, stitch sheer strength, thread strength, UV resistance, and stretchability. For example, FIGS. 1 and 2 illustrate a shoe 28 formed with the material described in U.S. Pat. No. 5,333,568. As illustrated in these images, when the material described in U.S. Pat. No. 5,333,568 is placed over a shoe last to form a three dimensional shoe upper 26, the material was incapable of being stretched over the shoe last to create the three dimensional shoe upper shape. Rather, the material had to be cut and sewn in multiple places to form the rounded shape needed for the shoe upper 26.

U.S. Pat. No. 5,935,678 describes a laminate structure in sheet form with first and second arrays of high performance, unidirectionally-oriented fiber bundles. The second array of fiber bundles is cross-plied at an angle to the first array of fiber bundles. A polymeric film resides between the first and second cross-plied arrays of fiber bundles to adhere the first and second arrays of fiber bundles together. This design provides a rigid structure for use as a ballistic laminate structure, but is problematic when the laminate is used in a process that requires some material deformation to form three dimensional objects.

US 2013/0219600 describes a multilayer non-woven fabric material composed of two or four non-woven fiber sheets of aramide/polyethylene fibers, impregnated with resin and/or a filler material, and oriented at various angles, which is used for manufacturing protection garments. The superimposed non-woven fabric layers are not bonded or glued together as a way to provide a flexible material for use in protective garments. While this design provides the necessary flexibility for use in garments, the design is similar to the flexible design taught in U.S. Pat. No. 5,333,568, and therefore also does not provide the necessary elasticity when the laminate is used in a process that requires some material deformation to form three dimensional objects. Furthermore, because the fabric layers are not bonded or glued together, the material has minimal, if any, delamination strength.

Thus, it is desirable to provide a nonwoven multilayered composite and/or laminated structure, wherein each layer comprises unidirectional high performance fibers, which provides a very low weight material with high tensile strength and some elasticity so that the structure may be used in a process that requires some material deformation to form three dimensional objects.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments to the present invention, a multilayered material for forming three dimensional objects comprises at least three nonwoven fiber layers. In other embodiments, the multilayered material for forming three dimensional objects comprises three nonwoven fiber layers.

Each fiber layer comprises a plurality of unidirectionally oriented fibers, wherein the fibers in a first one of the at least three nonwoven fiber layers form an angle in the range of −25° to −65° with respect to the fibers in another one of the at least three nonwoven fiber layers, and the fibers in a second one of the at least three nonwoven fiber layers form an angle in the range of +25° to +65° with respect to the fibers in another one of the at least three nonwoven fiber layers. The multilayered material comprises elastic properties that allow the multilayered material to deform by stretching the multilayered material over a three dimensional mold to form a three dimensional object.

In some embodiments, the multilayered material also comprises at least one outer layer adhered to a side of one of the at least three nonwoven fiber layers. The matrix material may further comprise a second outer layer adhered to a side of another one of the at least three nonwoven fiber layers. At least one of the outer layers may be formed of thermoplastic polyurethane and comprises screen printing.

In other embodiments, the multilayered material also comprises at least one thermoplastic polyurethane outer layer adhered to a side of one of the at least three nonwoven fiber layers. The matrix material may further comprise a second thermoplastic polyurethane outer layer adhered to a side of another one of the at least three nonwoven fiber layers. At least one of the thermoplastic polyurethane outer layers may comprise screen printing.

The matrix material may be formed of materials selected from the group consisting of thermoplastic polyurethane, other polyurethanes, silicone, ethylene propylene diene, polyvinyl chloride, thermoplastic elastomer, polylactic acid, polyamide, and polyethylene.

In some embodiments, the fibers in the first one of the at least three nonwoven fiber layers form an angle in the range of −30° to −60° with respect to the fibers in another one of the at least three nonwoven fiber layers, and the fibers in the second one of the at least three nonwoven fiber layers form an angle in the range of +30° to +60° with respect to the fibers in another one of the at least three nonwoven fiber layers. In other embodiments, the fibers in the first one of the at least three nonwoven fiber layers form an angle in the range of −40° to −50° with respect to the fibers in another one of the at least three nonwoven fiber layers, and the fibers in the second one of the at least three nonwoven fiber layers form an angle in the range of +40° to +50° with respect to the fibers in another one of the at least three nonwoven fiber layers.

According to some embodiments, the fibers are formed of materials selected from the group consisting of ultra high molecular weight polyethylene, other polyethylenes, polyester, nylon, Basalt, aramid, carbon, polymer/carbon composites, liquid crystal polymers, and high performance films.

In some embodiments, the multilayered material further comprises a woven layer. The woven layer may be printed and/or colored.

The at least three nonwoven fiber layers may be punctured to improve breathability of the multilayered material. The multilayered material may further comprise a wicking lining to transport moisture away from the multilayered material. In other embodiments, the multilayered material may further comprise a hydrophilic layer to pull moisture away from the multilayered material.

### BRIEF DESCRIPTION OF THE DRAWINGS

In the following detailed description, embodiments of the invention are described referring to the following figures:

FIG. 1 is a side view of a shoe formed with a conventional multilayered textile material with a 0°/90° configuration of two fiber layers and two outer layers of polyester.

FIG. 2 is a perspective view of the shoe of FIG. 6.

FIG. 3 is an exploded top view of one example of a process of forming a multilayered textile material with a −40°/0°/40° configuration between the fiber layers, according to certain embodiments of the present invention.

FIG. 4 is an exploded top view of the process of forming a multilayered textile material with a −50°/0°/50° configuration between the fiber layers, according to certain embodiments of the present invention.

FIG. 5 is an exploded top view of the process of forming a multilayered textile material with a −40°/0°/40° configuration between the fiber layers, according to certain embodiments of the present invention.

FIG. 6 is an exploded top view of the process of forming a multilayered textile material with a −50°/0°/50° configuration between the fiber layers, according to certain embodiments of the present invention.

FIGS. 7a-7c are left side, right side, and front views of a multilayered textile material, according to certain embodiments of the present invention, being stretched over a three dimensional mold.

FIG. 8 is a perspective view of a shoe formed with a multilayered textile, according to certain embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention provide textile materials having low weight, high tensile strength, and some elasticity for use with processes that require some material deformation to form three dimensional objects. While the textile materials are discussed having three fiber layers and two outer layers, they are by no means so limited. Rather, embodiments of the textile materials may include any suitable number of fiber and/or other layers as needed or desired to achieve three dimensional objects with the desired properties.

FIGS. 3-6 illustrate embodiments of a multilayered textile material 10. In these embodiments, the material 10 comprises a first outer layer 12, a first layer of unidirectionally oriented fibers (i.e., nonwoven fiber layer) 14, a second layer of unidirectionally oriented fibers (i.e., nonwoven fiber layer) 16 oriented at a first angle relative to the first fiber layer 14, a third layer of unidirectionally oriented fibers (i.e., nonwoven fiber layer) 18 oriented at a second angle relative to the first fiber layer 14, and a second outer layer 20.

While the embodiments illustrated in FIGS. 3-6 indicate that the material 10 includes three fiber layers, the material 10 may include any suitable combination of layers including but not limited to one nonwoven fiber layer 14, 16, or 18, two nonwoven fiber layers oriented at any suitable angle to each other in any combination of nonwoven fiber layers, or more than three nonwoven fiber layers.

According to certain embodiments, the first and second outer layers 12, 20 (i.e., matrix material) are formed of thermoplastic polyurethane (“TPU”). TPU provides good elasticity properties, which allow the material 10 to stretch when a load is applied in any direction that does not align with a direction of fiber orientation. The amount of stretch provided by the TPU material increases as the angle between the direction of the load application and the direction of the fiber orientation increases. In other words, when the direction of the load application is only a few degrees from the direction of the fiber orientation, the material 10 will stretch a small amount, but the amount of stretch will increase as the angle widens between the direction of the load application and the direction of the fiber. Other outer layer materials may include polyurethane (“PU”), silicone, ethylene propylene diene (“EPDM”), polyvinyl chloride (“PVC”), thermoplastic elastomer (“TPE”), polylactic acid (“PLA”), polyamide (“PA”), and polyethylene (“PE”), or other suitable materials. The first and second outer layers 12, 20 may be formed of the same or different materials to achieve the desired properties.

In some embodiments, the fibers in the first, second, and third fiber layers 14, 16, 18 are formed of UHMWPE. In certain embodiments, the UHMWPE fibers may be up to 15 times stronger than steel, but up to 40% lighter than materials like aramids. UHMWPE fibers have very little elasticity and are very difficult to break. Other fiber materials may include polyester fibers (such as the products sold under the trade name Dacron®), nylon fibers, natural fibers such as Basalt, aramid fibers (such as the products sold under the trade names Kevlar®, Techora®, and Twaron®), carbon fibers, high performance films (such as polyethylene naphthalate (“PEN”) films and products sold under the trade name Mylar®), polymer/carbon composites (such as single-wall carbon nanotubes (“SWCNT”) or graphene) and may include but is not limited to combinations of polyvinylalcohol/carbon and/or polyacrylonitrile/carbon, liquid crystal polymers (“LCP”) (such as products sold under the trade name Vectran®) and (poly (p-phenylene-2,6-benzobisoxazole)) (“PBO”) (such as products sold under the trade name Zylon®), polyethylenes (such as products sold under the trade names Ceran®, Dyneema®, and Spectra®) and PEN fibers (such as products sold under the trade name Pentex®), or other suitable materials. The first, second, and third fiber layers 14, 16, 18 may be formed of the same or different materials to achieve the desired properties.

In certain embodiments, the fibers within each individual fiber layer may be formed of the same material with the same properties. In other embodiments, one or more of the individual fiber layers may include fibers formed of at least two different materials. The fibers may be arranged within the individual fiber layer to create zones or in certain orders to vary the material properties of the individual fiber layer.

In certain embodiments, the fibers have a thickness of less than 1 denier. The tear strength of the material 10 is influenced by the density or number of crossover points between the fiber layers 14, 16, 18. Higher crossover densities may be achieved by smaller diameter fibers and/or increasing the number of threads in a given area. However, a person of ordinary skill in the relevant art will understand that different fiber thicknesses and concentrations may be used in the various fiber layers 14, 16, 18 to achieve the desired properties.

Each fiber layer 14, 16, 18 may be formed by coating each fiber with resin and pulling the resin-coated fibers in parallel through a die so that the fibers are laterally married to form a unidirectional tape. Additional description of one possibility regarding the formation of each fiber layer 14, 16, 18 is found in U.S. Pat. No. 5,333,568 and U.S. Pat. No. 5,470,632, the contents of each of which is incorporated herein by reference.

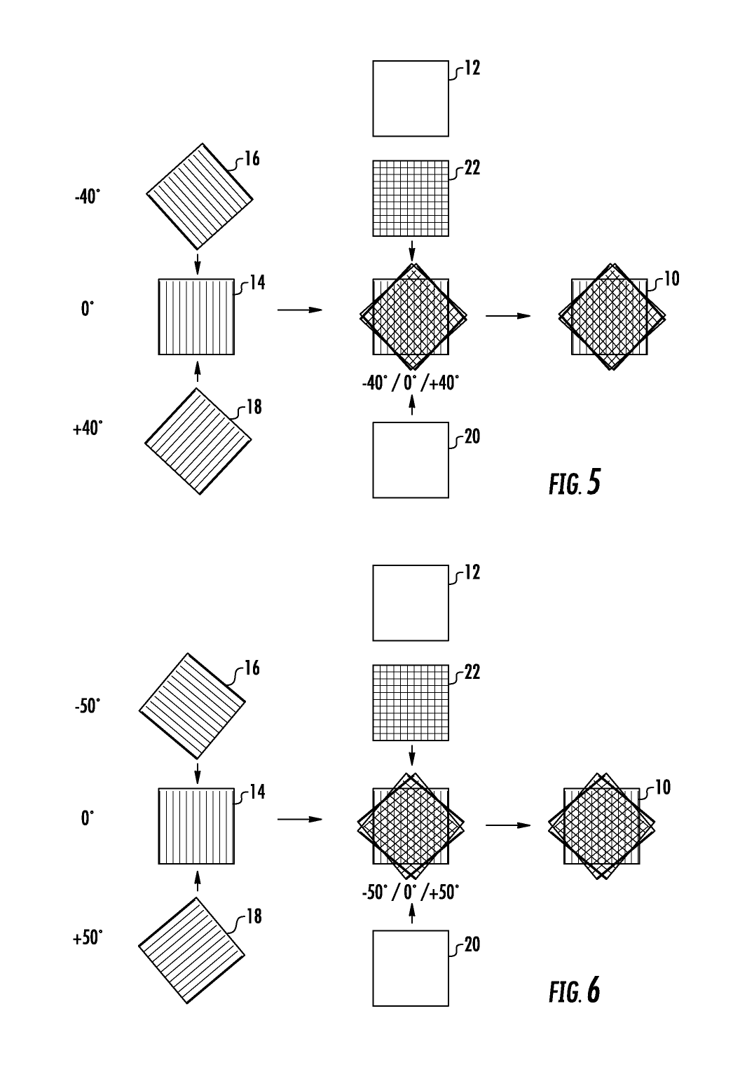

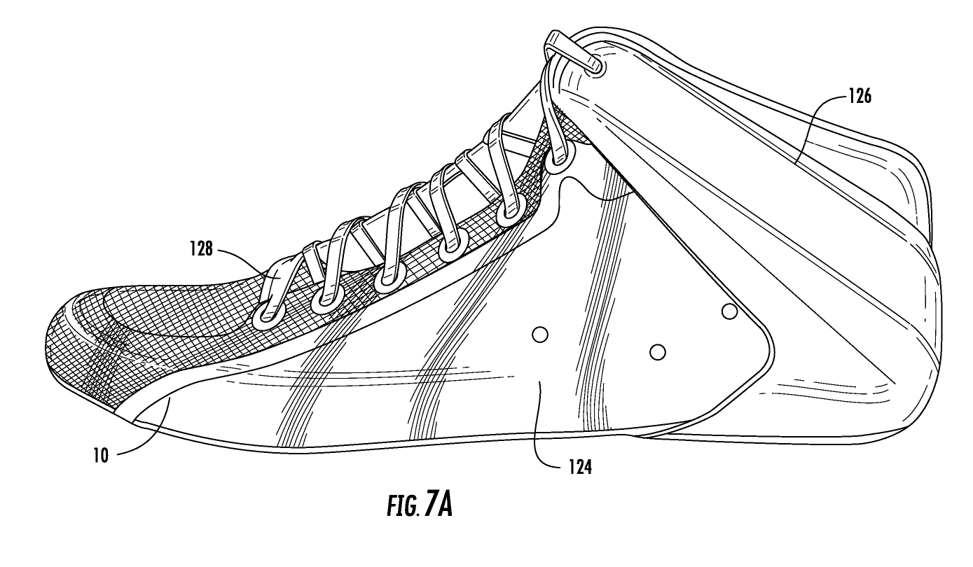

The three fiber layers 14, 16, 18 are arranged in a regular pattern in the range of) (−40°/0°/40° and (−50°/0°/50°), as illustrated in FIGS. 3-6. In other words, in the examples illustrated in FIGS. 3 and 5, the second fiber layer 16 is positioned adjacent the first fiber layer 14 so that the fibers in the second fiber layer 16 form an angle of −40° with respect to the fibers in the first fiber layer 14, and the third fiber layer 18 is positioned adjacent an opposite side of the first fiber layer 14 so that the fibers in the third fiber layer 18 form an angle of +40° with respect to the fibers in the first fiber layer 14. In certain embodiments, the arrangement of at least three fiber layers in the material 10 may range anywhere from (−25° to −65°)/0°/(+25° to +65°), may range anywhere from (−30° to −60°)/0°/(+30° to +60°), may range anywhere from (−35° to −55°)/0°/(+35° to +55°), or may range anywhere from (−40° to −50°)/0°/(+40° to +50°). Furthermore, the orientation of the fiber layers within these ranges may be symmetrical, such as the (−40°/0°/40°) and (−50°/0°/50°) embodiments illustrated in FIGS. 3-6, but it is also possible to have embodiments where the orientation of the fiber layers within these ranges may be asymmetrical, such as (43°/0°/−50°) or other asymmetrical variations. Similar ranges may be used for the arrangement of two fiber layers or four or more fiber layers in the material 10.

Other patterns, such as an asymmetrical pattern of (−90°/0°/45°), were tested but did not provide the appropriate amount of stretch to allow the material 10 to form the three dimensional object without wrinkles or folds. The resin-coating on the fibers that bonds the fibers to form the unidirectional tape of each fiber layer 14, 16, 18 may also be activated with heat and/or pressure to adhere the fiber layers 14, 16, 18 to each other.

As illustrated in FIGS. 3-6, the outer layers 12, 20 (i.e., matrix material) are placed above and below the three fiber layers 14, 16, 18. An adhesive, in addition to heat and/or pressure, may be used to bond the outer layers 12, 20 to the fiber layers 16 and 18. The resulting material 10 is a two-dimensional composite sheet.

In the embodiments where the outer layers 12, 20 are formed of TPU, the resulting material 10 has a nice appearance and feel, and the outer layers 12, 20 provide a surface that is easily connectable to other elements, such as other TPU layers and/or other TPU elements. For example, in the case of footwear, the material 10 may be easily connected to heel counters, midsoles, or TPU foils.

The features of material 10 according to certain exemplary embodiments are set forth below. However, these are just examples, as one of ordinary skill in the relevant art would understand that there may be other combinations and/or properties of the material 10 that are not illustrated in the table below.

| Material | | | |
|---|---|---|---|
| Description | Elasticity | Weight | Tensile Strength |
| −40°/0°/40° | 0° direction - 4% | 183 g/sqm | 0° direction - 148 N/cm |
| TPU outer layers | 90° direction - 56% | | 90° direction - 113 N/cm |
| | 52% increase in elasticity | | 24% decrease in tensile strength |
| | in the 90° direction | | in the 90° direction |
| −50°/0°/50° | 0° direction - 4% | 180 g/sqm | 0° direction - 156 N/cm |
| TPU outer layers | 90° direction - 26% | | 90° direction - 135 N/cm |
| | 22% increase in elasticity | | 13% decrease in tensile strength |
| | in the 90° direction | | in the 90° direction |

The values described in the table above represent the test results achieved from testing single samples of two embodiments of the material 10. Test results for additional samples of these embodiments may generate values that are higher or lower than those shown in the table above.

By way of comparison, the amount of elasticity demonstrated in a −90°/0°/45° polyester outer layer and −90 °/0°/45° TPU outer layer is approximately the same in both the 0° direction and the 90° direction, and the amount of tensile strength is also the same in both the 0° direction and the 90° direction. Thus, the difference between the elasticity and tensile strength exhibited in the 0° direction versus the 90° direction in the embodiments of material 10 described in the table above are indicative of the changes in material properties that would be exhibited by the various embodiments of the material 10 described herein as the angles between the fiber layers are varied.

While the values in the table above do not represent the entire range of results that may be obtained with various embodiments of the material 10, the results illustrate that the magnitude of elasticity gain in the 90° direction does not result in a corresponding magnitude of tensile strength loss in the 90° direction. In fact, the elasticity increase in the 90° direction is approximately twice the tensile strength loss in the 90 degree direction. This surprising result demonstrates that elasticity and tensile strength are not inversely and linearly correlated, but rather show that elasticity may be maximized without unduly sacrificing the material 10's tensile strength properties.

The use of outer layers 12, 20 formed of TPU also provides a surface that may be easily printed or colored, as illustrated in FIG. 8. Because the material 10 typically has a translucent appearance, the print may be applied to the side of the material 10 that will form the inner side, and the printing will be visible through the material 10. As a result, the material 10 itself will serve as a coating to protect the printing. In other embodiments, the print may be applied to the side of the material 10 that will form the outer side, and an additional coating layer may be applied to protect the printing. Printing to TPU surfaces may be accomplished with known methods including but not limited to screen printing.

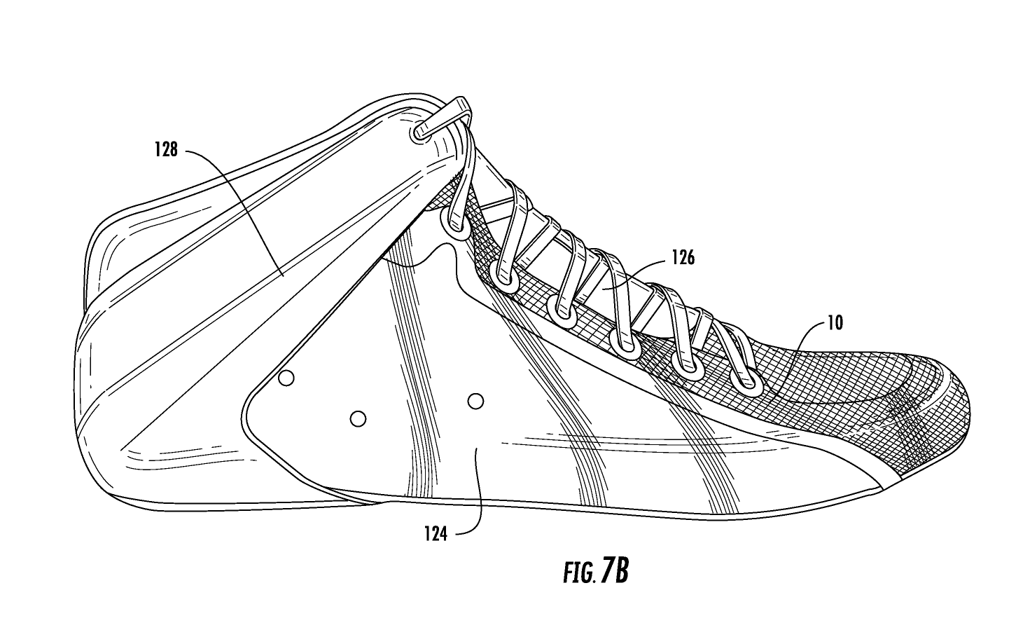

In other embodiments, as shown in FIGS. 5-6, an additional printed or colored woven layer 22 may be included in the material 10. The layer 22 may form an outer layer that is adhered to either of the outer layers 12, 20 or may be placed between any of the layers 12, 14, 16, 18, 20.

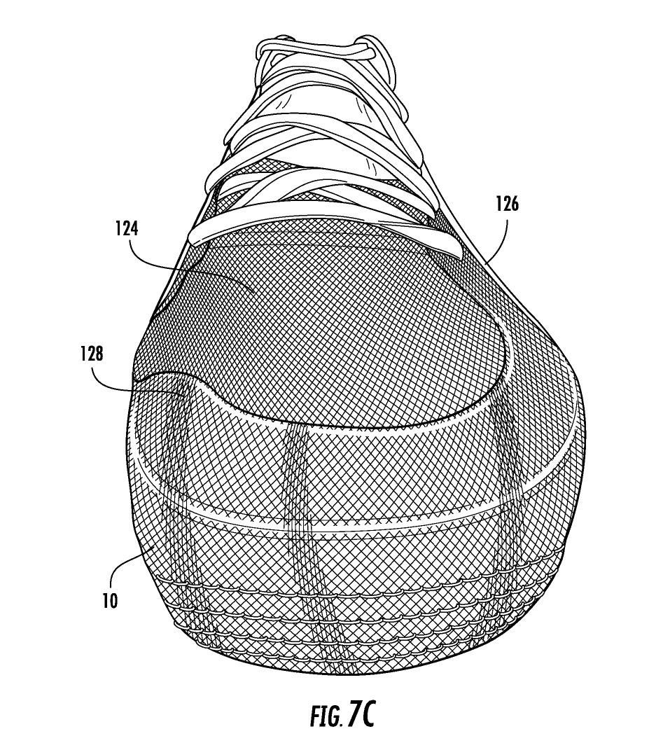

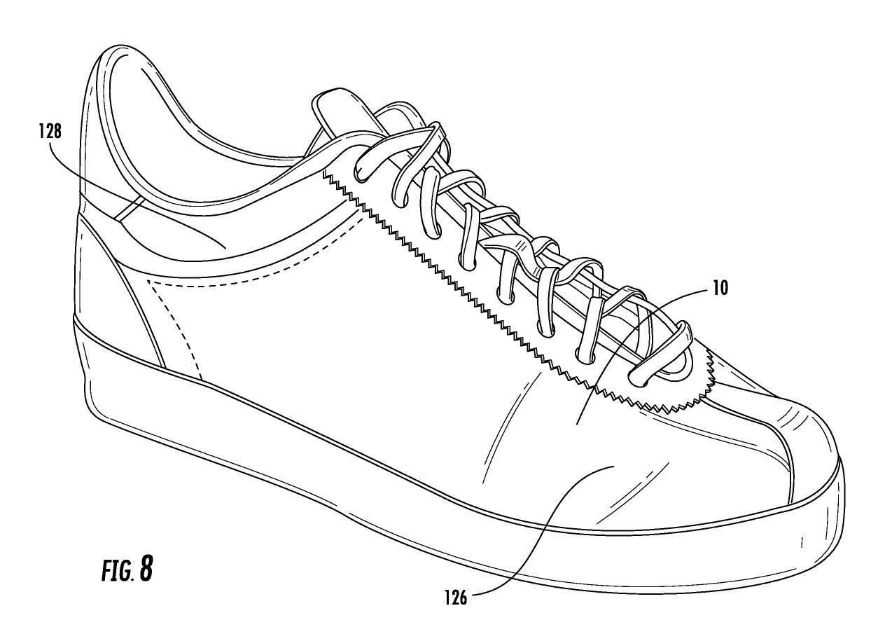

Because the fiber layers 14, 16, 18 typically do not have any breathability, perforation of the fiber layers 14, 16, 18, preferably between fibers, may be included to improve the breathability of the material. In other embodiments, a wicking lining may be included to transport moisture away from the material 10 to other areas that are not formed of the material 10, such as a breathable mesh area that may be located adjacent the material 10, as shown in FIGS. 7a-7c and 9-10). In still other embodiments, the material 10 may include a hydrophilic layer that is designed to pull sweat or other moisture away from the material 10. The material 10 may include one, all, or any combination of these embodiments to improve the breathability of the material 10.

In certain embodiments, the material 10 is then stretched in certain configurations to form a three dimensional object. For example, as shown in FIGS. 7a-7c, the material 10 is deformed through stretching to conform to the shape of a three dimensional mold 124. In these embodiments, the mold 124 is a shoe last that is used to form a shoe upper 126 for a shoe 128. However, a person of skill in the relevant art will understand that the material 10 may be used to conform to any three dimensional mold 124 where some deformation of the material 10 is required for the material 10 to conform to the mold 124 with a smooth appearance.

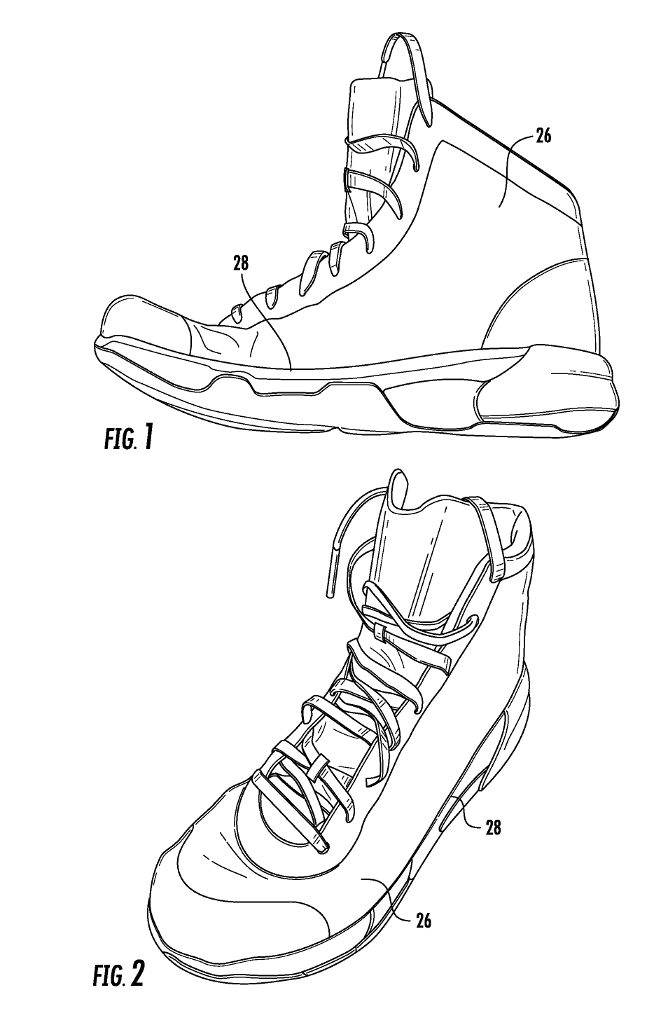

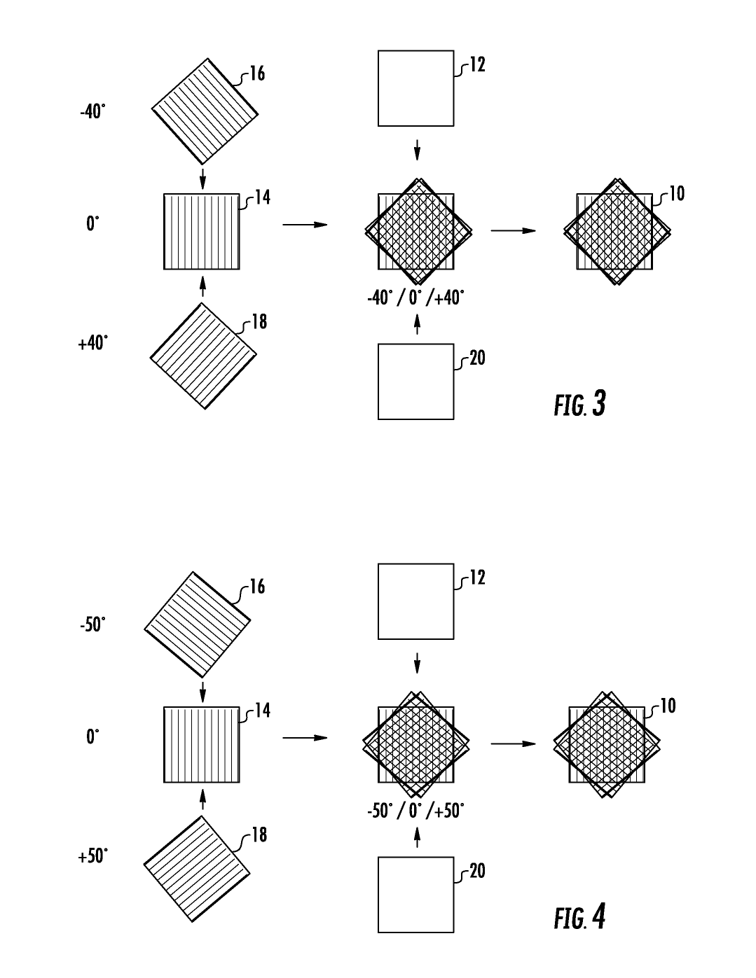

A finished three dimensional product formed through the deformation of the material 10 by stretching the material 10 over a three dimensional mold 124 is illustrated in FIG. 8. While the product shown in FIG. 8 is a shoe 128, one of skill in the relevant art will understand that the material 10 described above may be used with any three dimensional mold 124 to stretch and deform the material 10 into a suitable three dimensional object. As shown in FIG. 8, and in comparison to FIGS. 1-2, the material 10 has a smooth surface appearance without the need to cut or sew the material 10 to achieve the required three dimensional shape.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A multilayered material for forming three dimensional footwear objects comprising:
(a) at least three nonwoven fiber layers, each fiber layer comprising a plurality of unidirectionally oriented fibers, wherein the fibers in a first one of the at least three nonwoven fiber layers form an angle in the range of −25° to −65° with respect to the fibers in another one of the at least three nonwoven fiber layers, and the fibers in a second one of the at least three nonwoven fiber layers form an angle in the range of +25° to +65° with respect to the fibers in another one of the at least three nonwoven fiber layers; and
(b) a matrix material comprising at least one outer layer adhered to a side of one of the at least three nonwoven fiber layers;
wherein the multilayered material comprises elastic properties that allow the multilayered material to deform by stretching the multilayered material over a three dimensional mold to form a three dimensional footwear object.

2. The multilayered material of claim 1, wherein the matrix material further comprises a second outer layer adhered to a side of another one of the at least three nonwoven fiber layers.

3. The multilayered material of claim 1, wherein the matrix material is formed of materials selected from the group consisting of thermoplastic polyurethane, other polyurethanes, silicone, ethylene propylene diene, polyvinyl chloride, thermoplastic elastomer, polylactic acid, polyamide, and polyethylene.

4. The multilayered material of claim 2, wherein at least one of the outer layers is formed of thermoplastic polyurethane and comprises screen printing.

5. The multilayered material of claim 1, wherein the fibers in the first one of the at least three nonwoven fiber layers form an angle in the range of −30° to −60° with respect to the fibers in another one of the at least three nonwoven fiber layers, and the fibers in the second one of the at least three nonwoven fiber layers form an angle in the range of +30° to +60° with respect to the fibers in another one of the at least three nonwoven fiber layers.

6. The multilayered material of claim 1, wherein the fibers in the first one of the at least three nonwoven fiber layers form an angle in the range of −40° to −50° with respect to the fibers in another one of the at least three nonwoven fiber layers, and the fibers in the second one of the at least three nonwoven fiber layers form an angle in the range of +40° to +50° with respect to the fibers in another one of the at least three nonwoven fiber layers.

7. The multilayered material of claim 1, wherein the fibers are formed of materials selected from the group consisting of ultra high molecular weight polyethylene, other polyethylenes, polyester, nylon, Basalt, aramid, carbon, polymer/carbon composites, liquid crystal polymers, and high performance films.

8. The multilayered material of claim 1, further comprising a woven layer.

9. The multilayered material of claim 8, wherein the woven layer is printed.

10. The multilayered material of claim 9, wherein the woven layer is colored.

11. The multilayered material of claim 1, wherein the at least three nonwoven fiber layers are punctured to improve breathability of the multilayered material.

12. The multilayered material of claim 1, further comprising a wicking lining to transport moisture away from the multilayered material.

13. The multilayered material of claim 1, further comprising a hydrophilic layer to pull moisture away from the multilayered material.

14. A multilayered material for forming three dimensional footwear objects comprising:
(a) at least three nonwoven fiber layers, each nonwoven fiber layer comprising a plurality of unidirectionally oriented fibers, wherein the fibers in a first one of the at least three nonwoven fiber layers form an angle in the range of −25° to −65° with respect to the fibers in another one of the at least three nonwoven fiber layers, and the fibers in a second one of the at least three nonwoven fiber layers form an angle in the range of +25° to +65° with respect to the fibers in another one of the at least three nonwoven fiber layers; and
(b) at least one thermoplastic polyurethane outer layer adhered to a side of one of the the at least three nonwoven fiber layers;
wherein the multilayered material comprises elastic properties that allow the multilayered material to deform by stretching the multilayered material over a three dimensional mold to form a three dimensional footwear object.

15. The multilayered material of claim 14, further comprising a second thermoplastic polyurethane outer layer adhered to a side of another one of the at least three nonwoven fiber layers.

16. The multilayered material of claim 15, wherein at least one of the thermoplastic polyurethane outer layers comprises screen printing.

17. The multilayered material of claim 14, wherein the fibers in the first one of the at least three nonwoven fiber layers form an angle in the range of −30° to −60° with respect to the fibers in another one of the at least three nonwoven fiber layers, and the fibers in the second one of the at least three nonwoven fiber layers form an angle in the range of +30° to +60° with respect to the fibers in another one of the at least three nonwoven fiber layers.

18. The multilayered material of claim 14, wherein the fibers in the first one of the at least three nonwoven fiber layers form an angle in the range of −40° to −50° with respect to the fibers in another one of the at least three nonwoven fiber layers, and the fibers in the second one of the at least three nonwoven fiber layers form an angle in the range of +40° to +50° with respect to the fibers in another one of the at least three nonwoven fiber layers.

19. The multilayered material of claim 14, wherein the fibers are formed of materials selected from the group consisting of ultra high molecular weight polyethylene, other polyethylenes, polyester, nylon, Basalt, aramid, carbon, polymer/carbon composites, liquid crystal polymers, and high performance films.

20. The multilayered material of claim 14, further comprising a woven layer.

21. The multilayered material of claim 20, wherein the woven layer is printed.

22. The multilayered material of claim 21, wherein the woven layer is colored.

23. The multilayered material of claim 14, wherein the at least three nonwoven fiber layers are punctured to improve breathability of the multilayered material.

24. The multilayered material of claim 14, further comprising a wicking lining to transport moisture away from the multilayered material.

25. The multilayered material of claim 14, further comprising a hydrophilic layer to pull moisture away from the multilayered material.

26. A multilayered material for forming three dimensional footwear objects comprising:
(a) three nonwoven fiber layers, each nonwoven fiber layer comprising a plurality of unidirectionally oriented ultra high molecular weight polyethylene fibers, wherein the fibers in a first one of the three nonwoven fiber layers form an angle in the range of −25° to −65° with respect to the fibers in another one of the three nonwoven fiber layers, and the fibers in a second one of the the three nonwoven fiber layers form an angle in the range of +25° to +65° with respect to the fibers in another one of the three nonwoven fiber layers; and
(b) at least one thermoplastic polyurethane outer layer adhered to a side of one of the three nonwoven fiber layers; and
wherein the multilayered material comprises elastic properties that allow the multilayered material to deform by stretching the multilayered material over a three dimensional mold to form a three dimensional footwear object.

27. The multilayered material of claim 26, further comprising a second thermoplastic polyurethane outer layer adhered to a side of another one of the three nonwoven fiber layers.
